(19) United States
(12) Patent Application Publication
(10) Pub. No.: US 2026/0230173 A1
(43) Pub. Date: Aug. 6, 2026

(54) Methods and Apparatuses for Applying Ground-Based Digital Pre-Distortion in a Satellite Communications System

(71) Applicant: Viasat, Inc., Carlsbad, CA (US)

(72) Inventors: Kenneth V. Buer, Bluff City, TN (US); Rami Adada, Carlsbad, CA (US)

(21) Appl. No.: 19/159,082

(22) PCT Filed: Feb. 27, 2024
(86) PCT No.: PCT/US2024/017489

§ 371 Date: Aug. 22, 2025

Related U.S. Application Data
(60) Provisional application No. 63/487,209, filed on Feb. 27, 2023.

(51) Int. Cl. H04B 7/185

(52) U.S. Cl. CPC H04B 7/18515; H04B 7/18519

(57) ABSTRACT

Disclosed methods and apparatuses provide for ground based pre-distortion in a satellite communications system (SCS), where the ground based pre-distortion accounts for transmission related nonlinearities arising from the combination of uplink transmission of the communications signal by a terrestrial terminal and the corresponding downlink retransmission of the communications signal by a bent-pipe satellite of the SCS. In other words, pre-distortion applied on the ground in the digital domain accounts for amplification and other nonlinearities arising from both the uplink transmission and the space-based retransmission. A calibration procedure provides for determination of the pre-distortion, based on transmitting a calibration signal to the satellite and receiving a return version of the calibration signal from the satellite.

### TECHNICAL FIELD

Methods and apparatuses disclosed herein relate to applying digital pre-distortion in a ground segment of a satellite communications system.

### BACKGROUND

The phrase “transmit signal chain” refers at least to the amplification stage(s) associated with amplification of a signal for free-space transmission and corresponding reception at a remote receiver. In at least some contexts, the phrase may be understood as referring to the series of components and processes involved in preparing and transmitting a signal from a source to a destination. Various elements in an example transmit signal chain include, for example, modulation components, amplification components, filtering components, and frequency-conversion components. In at least some example contexts, a transmit signal chain includes the conversion from one signal domain to another, such as where electro-optical circuitry transmits an optical signal that is based on an electrical domain signal.

FIG. 1 illustrates a simplified transmit signal chain 2, which provides an output signal 4 as an amplified version of an input signal 6. According to the example, the input signal 6 is a digital signal—e.g., a stream of digital values representing an information carrying waveform—and a digital-to-analog converter (DAC) 8 of the transmit signal chain 2 converts the input signal 6 into an analog electrical signal 10, and a power amplifier (PA) 12 amplifies the analog electrical signal 10 to form the output signal 4, for transmission from an antenna (not shown).

Any practical transmit signal chain may exhibit characteristic nonlinearity, especially amplification nonlinearities. The relationship between the input signal 6 and the output signal 4 is nonlinear as a consequence of the nonlinearities of the transmit signal chain, with FIG. 2 illustrating example nonlinearities for the amplification portion of the transmit signal chain 2.

The gain response is not flat over the input power range, nor is the phase response. More complex nonlinear behavior may be observed in more complex transmit signal chains, which may include multiple meaningful sources of nonlinearity, including both amplification nonlinearity and modulation nonlinearity.

Known approaches to compensating for such nonlinearities include pre-distorting the input signal 6 in the digital domain, referred to as digital pre-distortion or “DPD.” DPD depends on creating a mathematical model that accurately represents the inverse of the nonlinearities exhibited by the transmit signal chain 2. Implementation of the model varies, such as look-up tables, polynomial models, or more complex adaptive algorithms. Ideally, the applied pre-distortion cancels—compensates—the nonlinearities, such that the output signal 4 has a linear relationship with the input signal 6, over the normal range of operation conditions for the transmit signal chain 2.

Significant challenges regarding the effective use of DPD arise in the context of satellite communications systems (SCSs), particularly in the context of using bent-pipe satellites for relaying signals between respective terrestrial terminals. In a bent-pipe configuration, a satellite operates in a passive role, receiving signals from one terrestrial terminal and retransmitting them for reception by another terrestrial terminal, without digital-domain processing and signal regeneration.

In more detail, a bent-pipe satellite receives one or more uplink signals through its receiver subsystem and transmits one or more corresponding downlink signals through its transmitter subsystem. The receiver subsystem interconnects to the transmitter subsystem through one or more signal pathways that do not decode or demodulate the information conveyed via the uplink signal. Instead, a bent-pipe satellite derives the downlink signal(s) from the received uplink signal(s) via analog-domain operations, such as by demultiplexing, filtering, amplifying, and frequency translating the received uplink signal(s).

### SUMMARY

Disclosed methods and apparatuses provide for ground based pre-distortion in a satellite communications system (SCS), where the ground based pre-distortion accounts for transmission related nonlinearities arising from the combination of uplink transmission of the communications signal by a terrestrial terminal and the corresponding downlink retransmission of the communications signal by a bent-pipe satellite of the SCS. In other words, pre-distortion applied on the ground in the digital domain accounts for amplification and other nonlinearities arising from both the uplink transmission and the space-based retransmission. A calibration procedure provides for determination of the pre-distortion, based on transmitting a calibration signal to the satellite and receiving a return version of the calibration signal from the satellite.

An example embodiment comprises a method of operation in a SCS, where the method includes generating a calibration signal at a first terrestrial terminal of the SCS and transmitting an uplink signal from the first terrestrial terminal for reception at a bent-pipe satellite. The uplink signal transmission is based on inputting the calibration signal into a first transmit signal chain of the first terrestrial terminal. Further, the method includes receiving a downlink signal from the bent-pipe satellite and recovering a return signal from the downlink signal that is a retransmission of the calibration signal as received at the satellite. Here, the retransmission performed via a second transmit signal chain onboard the satellite, and the downlink signal may be received at the first terrestrial terminal or at a second terrestrial terminal. The method also includes characterizing a combined nonlinearity of the first and second transmit signal chains by evaluating the return signal relative to the calibration signal, and, with respect to a communications signal to be transmitted from the first terrestrial terminal via the first transmit signal chain for retransmission by the satellite via the second transmit signal chain, pre-distorting the communications signal in the digital domain in dependence on the characterized combined nonlinearity.

A related embodiment comprises a terrestrial terminal configured for operation in a SCS. The terrestrial terminal includes processing circuitry configured to generate a calibration signal, and a transmit signal chain configured to form an uplink signal from the calibration signal, for transmission to a bent-pipe satellite. Further, the terrestrial terminal includes a receiving antenna and associated receiver circuitry configured to receive a downlink signal from the bent-pipe satellite and recover a return signal from the downlink signal. Here, the return signal is a retransmission of the calibration signal as received at the satellite, where the retransmission is performed via a second transmit signal chain onboard the satellite. Correspondingly, the processing circuitry is further configured to: characterize a combined nonlinearity of the first and second transmit signal chains by evaluating the return signal relative to the calibration signal; and with respect to a communications signal to be transmitted from the first terrestrial terminal via the first transmit signal chain for retransmission by the satellite via the second transmit signal chain, pre-distort the communications signal in the digital domain in dependence on the characterized combined nonlinearity.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a known, example transmit signal chain.

FIG. 2 is a plot of gain and phase nonlinearity associated with the example transmit signal chain.

FIG. 3 is a block diagram of a satellite communications system (SCS), according to one embodiment.

FIG. 4 is a block diagram of a terrestrial terminal configured for operation in a SCS, according to one embodiment.

FIG. 5 is a block diagram of a method of operation by a terrestrial terminal of a SCS, according to one embodiment.

FIGS. 6 and 7 are block diagrams of example details for a terrestrial terminal, according to respective embodiments.

FIGS. 8 and 9 are block diagrams of example details for a bent-pipe satellite, according to respective embodiments.

FIG. 10 is a block diagram of example details for calibration signal generation, according to one embodiment.

FIG. 11 is a block diagram of example details for return-signal recovery, according to one embodiment.

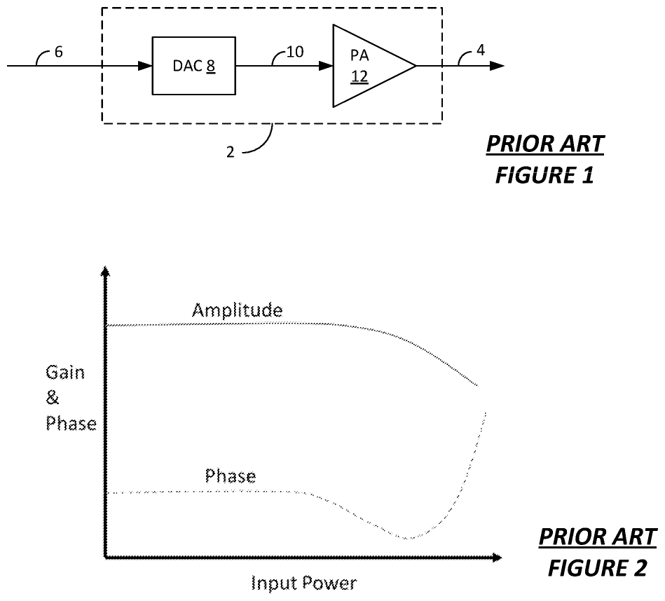

### DETAILED DESCRIPTION

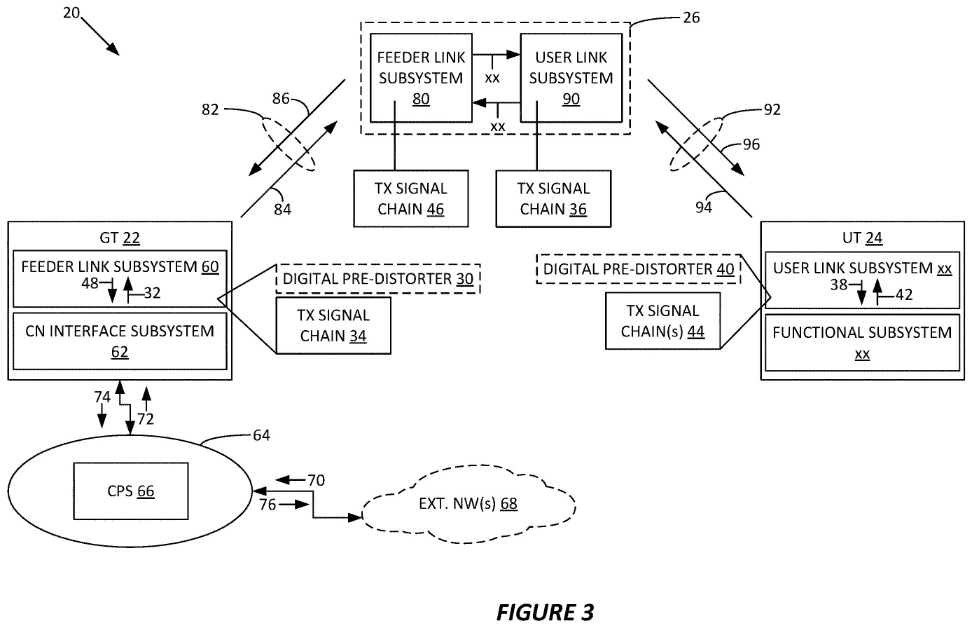

FIG. 3 depicts a satellite communications system (SCS) 20, in the sense that the diagram illustrates only one gateway terminal (GT) 22, only one user terminal (UT) 24, and only one bent-pipe satellite 26. Although not shown, it shall be understood that the SCS 20 may include multiple GTs 22 and multiple bent-pipe satellites 26, with each bent-pipe satellite 26 serving potentially many UTs 24.

“Bent pipe” refers to a type of satellite architecture where the satellite functions primarily as a relay station, receiving signals from a given terrestrial transmitter, amplifying the signals without modifying the signal contents, and retransmitting them for reception at another terrestrial terminal. Bent-pipe relaying can be understood as physical layer relaying or retransmission of signals going between respective terrestrial terminals. For convenience, the bent-pipe satellite 26 is referred to hereafter simply as the satellite 26.

In one or more embodiments, the GT 22 includes a digital pre-distorter 30 that applies digital pre-distortion to a forward communications signal 32 to be transmitted to the UT 24 via relaying through the satellite 26. Advantageously, the digital pre-distortion accounts for a combination of nonlinearities arising in the GT 22 with respect to initial transmission of the forward communications signal 32 by the GT 22, and retransmission of the forward communications signal 32 via the satellite 26. For example, the digital pre-distortion applied by the digital pre-distorter 30 accounts at least for amplifier nonlinearities arising in a transmit signal chain 34 of the GT 22 that is used for transmission of the forward communications signal 32 to the satellite 26, in combination with amplifier nonlinearities arising in a transmit signal chain 36 of the bent-pipe satellite 26 that is used for retransmission of the forward communications signal 32 as it was received at the satellite 26.

The digital pre-distortion applied by the GT 22 cancels or otherwise offsets the combination of nonlinearities, such that version of the forward communications signal 32 that is ultimately received by the UT 24 is linearized or at least has improved in linearity as compared to the absence of pre-distortion. In the diagram, the forward communications signal 38 at the UT 24 shall be understood as the ultimately received version of the forward communications signal 32 transmitted by the GT 22. Of course, the same pre-distortion can be applied where the end target is another GT 22 reached by relaying through the satellite 26.

In the same embodiment(s), or in one or more other embodiments, the UT 24 includes a digital pre-distorter 40 that applies digital pre-distortion to a return communications signal 42 to be transmitted by the UT 24 for relaying to the GT 22 via the satellite 26. Advantageously, the digital pre-distortion applied in the UT 24 accounts for nonlinearities arising in the UT 24 with respect to transmission of the return communications signal 42, in combination with nonlinearities arising from retransmission by the satellite 26. For example, the digital pre-distortion applied by the digital pre-distorter 40 accounts for amplifier nonlinearities arising in a transmit signal chain 44 of the UT 24 that is used for transmission of the return communications signal 42 in combination with amplifier nonlinearities arising in a transmit signal chain 46 of the bent-pipe satellite 26 that is used for retransmission of the return communications signal 42, as it was received at the bent-pipe satellite 26.

The digital pre-distortion applied by the UT 24 cancels or otherwise offsets the combination of nonlinearities, such that version of the return communications signal 42 that is ultimately received by the GT 22 is linearized or at least has reduced nonlinearity. In the diagram, the return communications signal 48 at the GT 22 shall be understood as the ultimately received version of the return communications signal 42 at the UT 24. Of course, the same pre-distortion can be applied for UT-to-UT communications that are relayed via the satellite 26.

A better understanding of the advantageous digital pre-distortion may be had with reference to the overall operation of the SCS 20, where the example GT 22 comprises a feeder link subsystem 60 and a CN interface subsystem 62. The feeder link subsystem 60 includes the aforementioned transmit (TX) signal chain 34 and, more generally, can be understood as RF or optical transceiver circuitry, along with associated transmission and reception components. In a case where the feeder link subsystem 60 includes an RF transceiver, it further includes, as said transmission/reception components, one or more RF antennas for RF signal transmission and reception. In a case where the feeder link subsystem 60 includes an optical transceiver, it further includes one or more optical telescopes for optical signal transmission and reception.

The CN interface subsystem 62 includes, for example, timing synchronization circuitry in or associated with a computer network interface that communicatively couples the GT 22 to a core network (CN) 64. The CN 64 includes one or more computer servers and routers or switches collectively configured as a communications processing system (CPS) 66. The CPS 66 interfaces the SCS 20 to one or more external networks 68, such as the Internet or other packet data networks. User traffic 70 incoming to the CN 64 from the external network(s) 68 is processed by the CPS 66 and forwarded to the GT 22 as forward traffic 72 for formation/transmission of corresponding forward communications signals 32.

To the extent that the SCS 20 includes multiple GTs 22 and to the extent that different GTs 22 are in communication with different satellites 26 that serve different populations or groups of UTs 24, the CPS 66 routes forward traffic to each GT 22 in dependence on which UTs 24 are served through that particular GT 22. The CN interface subsystem 62 also outputs return traffic incoming to GT 22 from UTs 24 via relaying through the satellite 26, for forwarding by the CPS 66 as outgoing user traffic 76.

Onboard the bent-pipe satellite 26, there a feeder link subsystem 80 configured for communicatively coupling the bent pipe satellite 26 to the GT 22 via a feeder link 82. In embodiments where the feeder link 82 is a RF feeder link, the feeder link subsystem 80 includes a RF transceiver and one or more associated RF antennas. For example, the feeder link 82 is an E-band link.

In embodiments where the feeder link 82 is an optical feeder link, the feeder link subsystem 80 includes an optical transceiver and one or more associated optical telescopes.

Whether implemented in the RF domain or in the optical domain, the feeder link 82 includes a feeder uplink signal 84 transmitted by the feeder link subsystem 60 of the GT 22, for reception by the feeder link subsystem 80 of the satellite 26. Further included is a feeder downlink signal 86 transmitted by the feeder link subsystem 80 of the satellite 26, for reception by the feeder link subsystem 60 of the GT 22.

A user link subsystem 90 onboard the satellite 26 supports a user link 92, also referred to a service link. The user link 92 communicatively couples the satellite 26 with the UTs 24 it serves. In the return direction, user uplink signals 94 transmitted by UTs 24 are received by the user link subsystem 90, with those signals, or signals derived therefrom, retransmitted to the GT 22 via the feeder link subsystem 80. In the forward direction, the user link subsystem 90 transmits user downlink signals 96, for reception by UTs 24. In one or more embodiments, the user downlink 92 is a RF downlink, e.g., in the L-, S-, or C-bands, and the user link subsystem 90 comprises a RF transceiver and one or more associated RF antennas.

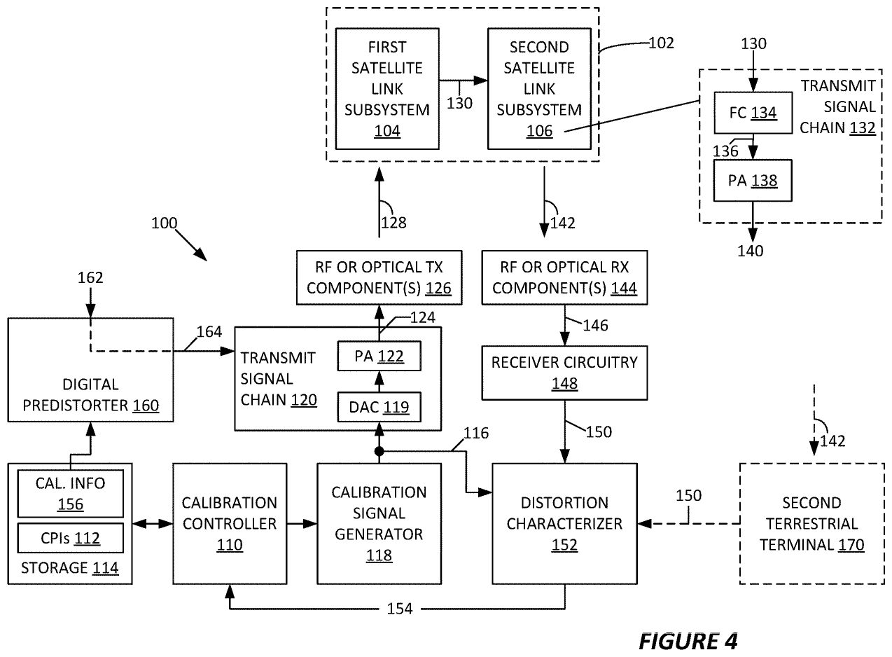

Because the advantageous pre-distortion may be practiced by a GT 22 for forward-link transmissions or at a UT 24 for return-link transmissions, FIG. 4 depicts a genericized arrangement, including a “first” terrestrial terminal 100, which may be either a GT 22 or a UT 24. FIG. 4 also depicts a bent-pipe satellite 102 having a first satellite link subsystem 104 and a second satellite link subsystem 106. In the case where the first terrestrial terminal 100 is a GT 22, the first satellite link subsystem 104 is a feeder link subsystem, such as the feeder link subsystem 80 shown in FIG. 3, and the second satellite link subsystem 106 is a user link subsystem, such as the user link subsystem 90 shown in FIG. 3. In the case where the first terrestrial terminal 100 is a UT 24, the first satellite link subsystem 104 is a user link subsystem, such as the user link subsystem 90 shown in FIG. 3, and the second satellite link subsystem 106 is a feeder link subsystem, such as the feeder link subsystem 80 shown in FIG. 3.

A signal transmitted by the first terrestrial terminal 100 experiences amplification and, possibly, other nonlinearities at the first terrestrial terminal 100, which are particular to the transmit signal chain used in the transmission. Additional nonlinearities are imparted in the retransmission of the satellite-received version of the signal, according to the particular transmit signal chain onboard the satellite 102 for the retransmission. The first terrestrial terminal 100 is configured to calculate, learn, or otherwise estimate these combined nonlinearities, for use in digital pre-distortion of communications signals that will be transmitted and retransmitted using those same transmit signal chains. The pre-distortion at least partly compensates for the combined nonlinearities.

According to one or more embodiments, the first terrestrial terminal 100 includes a calibration controller 110, which comprises fixed circuitry or programmatically configured circuitry or a mix of both. In at least one embodiment, the calibration controller 110 comprises one or more digital processors, e.g., microcontrollers or digital signal processors, that is/are specially adapted to carry out a calibration algorithm, also referred to as a calibration procedure, based on the execution of store computer program instructions (CPIs) 112 held in associated storage 114. The storage 114 comprises, for example, a mix of volatile and nonvolatile memory for long term data and program storage and for live run-time operations. Indeed, the calibration controller 110 may be associated with or subsumed by processing circuitry that is included in the first terrestrial terminal 100 for overall terminal control and communications signal processing.

According to an example implementation of the calibration procedure, the calibration controller 110 initiates generation of a calibration signal 116 by a calibration signal generator 118. In one or more embodiments, the calibration signal generator 118 is subsumed in the digital processing circuitry that comprises the calibration controller 110, i.e., it comprises programmatically configured processing logic.

The calibration signal 116 is generated in the digital domain in one or more embodiments. For example, it comprises a stream of digital waveform samples. In one or more embodiments, the calibration signal 116 is a digitized continuous wave (CW) signal that is swept over one or more signal parameters, for which nonlinearity is expected to vary. Example swept parameters include any one or more of signal power, signal frequency, or signal phase. Sweeping in this manner allows for characterization of changing nonlinearity over the sweep range(s). To the extent that more than one signal parameter is swept, the sweeping may be done simultaneously or separately.

The calibration signal 116 is applied to a digital-to-analog converter (DAC) 119 included in a transmit signal chain 120 that is the subject of the calibration procedure. If there are multiple transmit signal chains, each may be characterized in combination with the satellite 102. For clarity of reference, the transmit signal chain 120 may be referred to as a first transmit signal chain 120. The transmit signal path includes one or more additional items, with the diagram illustrating a power amplifier (PA) 122 as a significant one among such additional items. That is, the PA 122 is expected to contribute significantly to nonlinearities imparted to the calibration signal 116. The PA depiction is generic and can be understood to encompass either RF domain amplification or optical domain amplification.

The resulting amplified signal 124 is coupled into RF or optical transmit (TX) components 126, which output a corresponding uplink signal 128 for reception by the first satellite link subsystem 104 of the satellite 102. The RF or optical TX components 126 comprise, for example, a RF antenna system or an optical telescope, and the uplink signal 128 correspondingly may comprise a RF or optical uplink signal. In either case, the first satellite link subsystem 104 onboard the satellite 102 receives the uplink signal 128 and outputs a received version of the original calibration signal 116, denoted in the diagram as received calibration signal 130. Although the received calibration signal 116 may have any number of impairments associated with the amplification, transmission, reception, and recovery operations that yield the received calibration signal 130, the nonlinearities associated with amplification at the first terrestrial terminal 100 may be dominant, or are at least persistent and characterizable.

The second satellite link subsystem 106 of the satellite 102 includes a transmit signal chain 132 that, in the example depiction, includes a frequency converter (FC) 134 configured to translate or shift the received calibration signal 130 in frequency. For example, the received calibration signal 130 may be recovered as an intermediate frequency (IF) analog waveform, and the FC 134 may be configured to translate the calibration signal to frequency used for downlink transmission. A PA 138 is included in the transmit signal path and it amplifies the frequency-converted signal 136 output by the FC 134, to yield an amplified signal 140. The second satellite link subsystem 106 shall be understood as further comprising one or more RF or optical TX elements, that output the amplified signal 140 as a downlink signal 142, which also may be referred to as a downlink calibration signal.

In one embodiment or example implementation of the calibration procedure, the first terrestrial terminal 100 receives the downlink signal 142. In this respect, consider a specific example where the first terrestrial terminal 100 is a GT 22. In that case, the uplink signal 128 is consistent with the signal type and spectrum used by the GT 22 for feeder link communications, and the downlink signal 142 is consistent with the signal type and spectrum used for user link communications.

The diagram illustrates the inclusion of RF or optical receiver (RX) components 144 at the first terrestrial terminal 100, for reception of the downlink signal 142. The RF or optical RX components 144 comprise, for example, a RF antenna or an optical telescope. If the first terrestrial terminal 100 is a GT 22, the downlink signal 142 will be a user downlink signal in RF spectrum. A conventional GT may not be configured to receive user link signals but it shall be understood that a GT 22 according to one or more embodiments disclosed herein is augmented as needed for reception of a calibration-related downlink signal 142 that is transmitted in a RF spectrum used for the user link.

The RF or optical RX components output a received signal 146 and receiver circuitry 148, e.g., one or more filters, low-noise amplifiers (LNAs), and analog-to-digital converters (ADCs), extract or otherwise recover the retransmitted version of the calibration signal 116 as a received calibration signal 150. To avoid confusion with respect to the received calibration signal discussed in the context of the satellite 102, the received calibration signal 150 will be referred to as a return signal 150. The return signal 150 is the transmitted/retransmitted version of the original calibration signal 116 and may be thought of as a looped-back version of the calibration signal 116 and it manifests a combination of nonlinearities imparted by the first transmit signal chain 120 at the first terrestrial terminal 100 and the second transmit signal chain 132 onboard the satellite 102.

As noted with respect to the prospect of there being multiple transmit signal chains at the first terrestrial terminal 100 (ground transmit signal chains), there may be multiple transmit signal chains onboard the satellite 102 (space transmit signal chains), for use in signal retransmission. A calibration signal may be transmitted and looped back for evaluation with respect to any particular ground transmit signal chain that will be used in combination with a particular space transmit signal chain for combined transmission/retransmission of a communications signal.

In the illustrated example, a distortion characterizer 152 performs such evaluation on the return signal 150. The distortion characterizer 152 in one or more embodiments comprises programmatically configured logic circuitry and it may be subsumed into the processing circuitry used for implementation of the calibration controller 110. In operation, the distortion characterizer 152 compares corresponding signal values—digital domain samples—in the calibration signal 116 and the return signal 150, for characterization of the combined nonlinearities. By observing deviation of the return signal 150 from the calibration signal 116, the distortion characterizer 152 determines compensation values or information 154, which may be referred to as characterized pre-distortion 154. The characterized pre-distortion 154 may be stored in the storage 114 as calibration information 156, for subsequent use in pre-distorting communications signals that are transmitted/retransmitted using the same combination of first and second transmit signal chains 120 and 132.

In one or more embodiments, the characterized pre-distortion 154 takes the form of a lookup table or other indexed data structure, and it may contain a plurality of pre-distortion values corresponding to each swept signal parameter. For example, there may be a plurality of pre-distortion values corresponding to different subranges of communications signal power over a defined power range. In a particular example, the characterized pre-distortion 154 comprises a first set of compensation values used for compensating gain nonlinearities over a range of communications signal power, and second set of compensation values used for compensating phase linearities over a range of communications signal phase. In general, the characterized pre-distortion 154 may include respective compensation values for multiple sources or types of nonlinearity.

Digital pre-distortion in at least one embodiment comprises selecting specific gain and phase compensation values for modifying digital values of the communications signal, as a function of the signal amplitude and phase. It should also be understood that the characterized pre-distortion 154 may be represented in mathematical form, rather than as tables of precomputed values. For example, the distortion characterizer 152 determines the coefficients needed to fit an n-th order polynomial to a characterized gain nonlinearity curve and to fit another n-th or m-th order polynomial to a characterized phase nonlinearity curve. In such examples, the calibration information 156 held in the storage 114 comprises the determined coefficients. Regardless of such details, a digital pre-distorter 160 of the first terrestrial terminal 100 uses the calibration information 156 to apply pre-distortion to a communications signal 162, to produce pre-distorted communications signal 164, for transmission/retransmission via the first and second transmit signal chains 120 and 132.

Noteworthy here is that the calibration procedure may skip at least a portion of the overall transmit signal path provided by the transmit signal chain 120. For example, while the pre-distorted communications signal 164 may be error coded, modulated, etc., before being converted by the DAC 119 and amplified via the PA 122, the calibration signal 116 may skip that part of the path or be passed through it transparently.

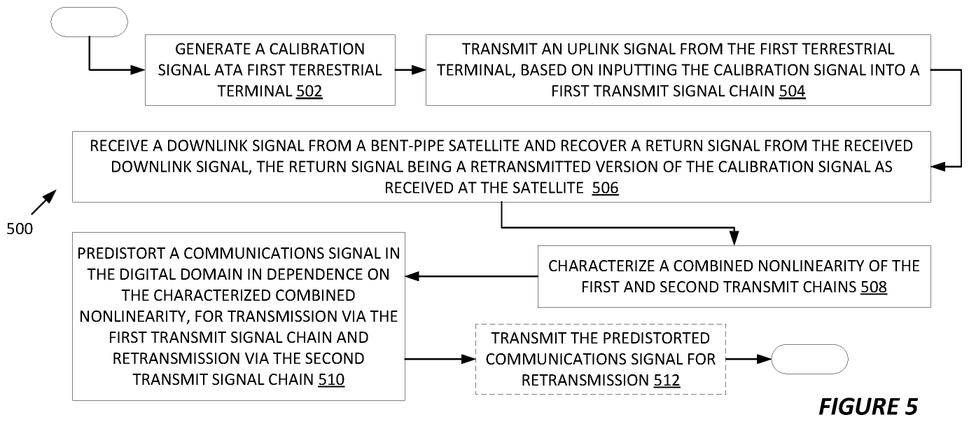

FIG. 5 depicts a method 500, which can be understood as one embodiment of the calibration algorithm performed by the first terrestrial terminal 100. The method 500 includes: generating (block 502) a calibration signal 116 at the first terrestrial terminal 100; transmitting (block 504) an uplink signal 128 from the first terrestrial terminal 100 for reception at a bent-pipe satellite 102, based on inputting the calibration signal 116 into a first transmit signal chain 120 of the first terrestrial terminal 100; receiving (block 506) a downlink signal 142 from the bent-pipe satellite 102 and recovering a return signal 150 from the received downlink signal, where the return signal is a retransmitted version of the calibration signal as received at the satellite 102 and transmitted via a second transmit signal chain 132; characterizing (block 508) a combined nonlinearity of the first and second transmit signal chains 120 and 132 by evaluating the return signal 150 relative to the calibration signal 116; and with respect to a communications signal 162 to be transmitted from the first terrestrial terminal 100 via the first transmit signal chain 120 for retransmission by the satellite 102 via the second transmit signal chain 132, pre-distorting (Block 510) the communications signal 162 in the digital domain in dependence on the characterized combined nonlinearity.

The method 500 may further comprise the first terrestrial terminal transmitting the pre-distorted communications signal 164 via the first transmit signal chain 120. Further, as suggested in FIG. 4, the method 500 may be varied such that a second terrestrial terminal 170 receives the downlink signal 142 from the satellite 102, rather than the first terrestrial terminal 100 receiving it. The second terrestrial terminal 170 provides the return signal 150 to the first terrestrial terminal 100, or it provides raw samples of the downlink signal 142, for use by the first terrestrial terminal 100 in obtaining the return signal 150 conveyed therein. In a context where the first terrestrial terminal 100 is a GT 22, this variation has the advantage of not requiring the GT 22 to be configured for receiving signals in the user link spectrum.

In at least one embodiment, or under certain example operational scenarios, the first transmit signal chain 120 of the first terrestrial terminal 100 includes an amplification stage operated at different operating points when used for transmitting communications signals. For example, the depicted PA 122 is operated at different operating points in dependence on mode or circumstances. The method 500 in one or more related variations includes characterizing the combined nonlinearity for the different operating points, such that pre-distortion of the communications signal 162 is operating point dependent. In this regard, the calibration information 156 may comprise respective sets of pre-distortion values, or respective pluralities of sets for different sweep parameters, with different ones of these respective sets or respective pluralities of sets corresponding to the different operating points, to be selected and used on an operating-point basis.

In at least one embodiment, the calibration signal 116 is an electrical domain signal and the uplink signal 128 is an optical domain signal, and wherein the first transmit signal chain 120 forms the uplink signal 128 by modulating an optical carrier responsive to the calibration signal 116. In particular, the calibration signal 116 may comprise a stream of digital samples, which are converted into an analog waveform, with that waveform then used to modulate the optical carrier.

In at least one other embodiment, the calibration signal 116 is an electrical domain signal at an intermediate frequency (IF), and wherein the first transmit signal chain 120 forms the uplink signal 128 by translating the calibration signal 116 to an uplink transmit frequency. In particular, the calibration signal 116 may comprise a stream of digital samples, which are then converted into an analog waveform at IF, with that waveform then translated to the uplink transmit frequency.

Generating (block 502) the calibration signal 116 comprises, for example, sweeping a continuous wave (CW) signal according to one or more signal parameters. The sweeping may be performed in the digital domain, of course, where the calibration signal 116 comprises digital samples having changing values representing a sweep over one or more ranges of signal parameters, such as any one or more of input signal power, input signal phase, or input signal frequency. Here, “input signal” refers to the calibration signal 116 being input to the first transmit signal chain 120.

Thus, characterizing (block 508) the combined nonlinearity of the first and second transmit signal chains 120 and 132 comprises, in at least one embodiment, characterizing the combined nonlinearity of the first and second transmit signal chains 120 and 132 over the defined sweep range corresponding to each of the one or more signal parameters. Such operations comprise, for example, determining one or more functions or look-up tables that cancel observed nonlinearity over the defined sweep range with respect to the one or more signal parameters. As an example, the calibration may be performed with respect to a defined phase sweep of the calibration signal 116 and with respect to a defined amplitude sweep of the calibration signal 116. In at least one embodiment, these phase and amplitude sweeps are repeated for a plurality of frequencies, over a defined frequency range, such that the functions/look-up tables are frequency-dependent functions/look-up tables. This arrangement accounts for frequency-dependent changes in the nonlinearity.

The corresponding pre-distortion instantaneously applied by the first terrestrial terminal 100 to the communications signal 162 for transmission is therefore a function of the instantaneous phase and amplitude of the communications signal 162—e.g., characterizing (block 508) the combined nonlinearity of the first and second transmit chains 120 and 132 comprises determining one or more functions or look-up tables that cancel observed nonlinearity over the defined range that each of the one or more calibration signal parameters is swept.

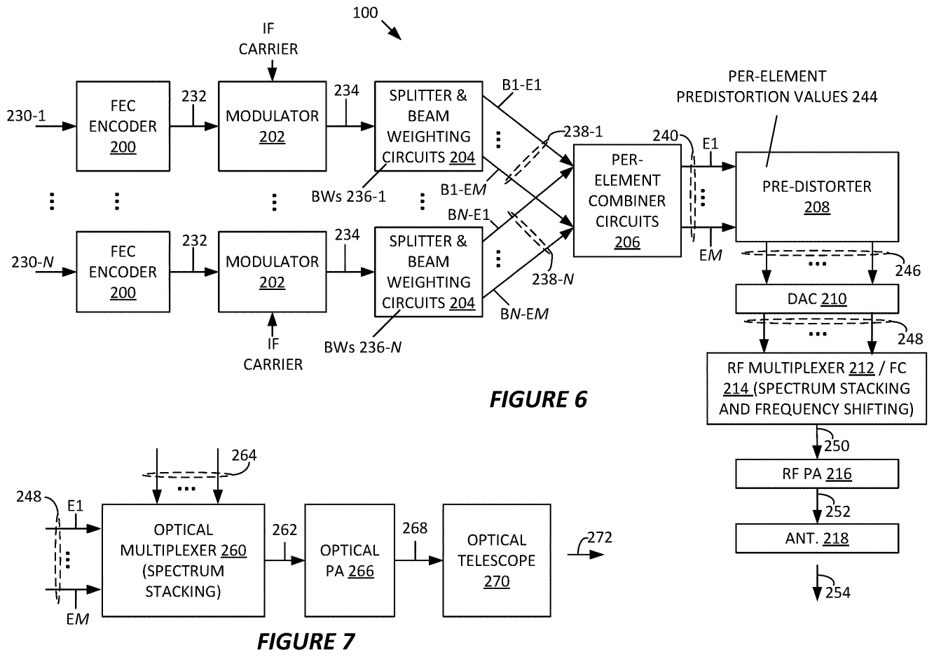

FIG. 6 illustrates an embodiment of the first terrestrial terminal 100 as configured for ground based beamforming (GBBF). In such embodiments, the satellite 102 has a phased array antenna for supporting the GBBF operations.

With respect to communications signal transmission, the first transmit signal chain 120 according to the illustrated example includes a signal path containing forward error correction (FEC) encoders 200, modulators 202, splitter and beam weighting circuits 204, per-element combiner circuits 206, a pre-distorter 208, a DAC 210, a RF multiplexer 212, frequency converters 214, a RF PA 216, and a RF transmit antenna 218.

Assume that GBBF is used to form N user beams, where N is an integer and may be >>1. Each beam has a corresponding beam coverage area, with each beam being a directional signal transmission conveying traffic for one or more other terrestrial terminals. In a forward-link example, the first terrestrial terminal 100 is a GT 22 and the beams are forward user beams having forward user beam coverage areas. Each forward user beam serves one or more UTs 24.

The traffic to be conveyed by each user beam is represented in FIG. 6 as a corresponding beam signal 230. For N beams, there are N beam signals 230, distinguished as signals 230-1 through 230-N in the diagram. Each beam signal 230 undergoes FEC encoding to produce a corresponding encoded beam signal 232, and each encoded beam signal 232 is used to modulate an IF carrier to form a corresponding modulated signal 234.

Each modulated signal 234 is split into a plurality of duplicate signals via a respective one of the splitter and beam weighting circuits 204. Particularly, with M antenna elements of the phased array antenna onboard the satellite 102 being used by GBFF for formation of the N beams, each modulated signal 234 is split into M duplicate signals. Each one of these duplicate signals corresponds to a particular one of the antenna elements of the phased array antenna, and it is weighted according to a corresponding beam weight from a set of beam weights 236.

In more detail, there are N sets of beam weights 236, shown as sets of beam weights 236-1 through 236-N. Each such set is calculated so that simultaneous transmission of the weighted versions of the corresponding M duplicate signals from the phased array antenna results in far field signal superpositions—patterns of constructive and destructive interference—that yield a corresponding one of the beams. As such, each set of beam weights 236 is calculated based on channel state information (CSI) determined by or for at least one of the terrestrial terminals to be served by the beam. The beam weights may be complex values, for weighting signal amplitude and phase.

With this arrangement, the splitter and beam weighting circuits 204 corresponding to each beam signal 230 output M weighted signals 238, each such signal weighted for transmission from a corresponding one of the antenna elements of the phased array antenna onboard the satellite 102. With each set of M weighted signals 238 corresponding to a particular one of the N beam signals 230, there are N such sets, shown as 238-1 through 238-N in the diagram. These weighted signals 238 may be referred to as beam element signals 238, to connote the fact that they are weighted versions of the beam signals and are mapped for transmission from respective ones of the antenna elements of the phased array antenna onboard the satellite 102.

The per-element combiner circuits 206 form a combined set of beam element signals 240, by performing per-element combining across the respective sets of beam element signals 238. That is, for each beam 1 through N, there are M beam element signals 238, each one to be transmitted by a particular one of the antenna elements. Thus, all beam element signals 238 associated with the same antenna element are linearly combined across the N sets of beam element signals 238 to yield a corresponding one of the combined beam element signals 240.

Each combined beam element signal 240 may be understood as a respective communications signal to be transmitted, and a key consideration is that the received version of each such beam element signal 240 at the satellite 102 is retransmitted via a respective one among a plurality of transmit signal paths—i.e., each antenna element has an associated version or copy of the previously discussed second transmit signal chain 132. As such, a pre-distorter 242 applies per-element pre-distortion values 244 to the combined beam element signals 240. A more specific formulation is to say that because the satellite 102 includes a respective bent pipe transmit signal path for each antenna element of the phased array antenna, the pre-distortion applied to each combined beam element signal has to account for the nonlinearity imparted by the transmit signal path in the satellite that is associated with the antenna element to which the beam element signal 240 corresponds.

The resulting M pre-distorted signals 246 output by the pre-distorter 242 feed into a DAC 210, which outputs a corresponding set of M analog signals 248 that are multiplexed by the RF multiplexer 212/FC 214 to form a multiplexed signal 250. As one example, the multiplexed signal 250 contains a plurality of RF signals uniformly spaced in the RF spectrum, going from a lower frequency to an upper frequency and with guard frequencies therebetween. The arrangement can be understood as “spectrum stacking” of the analog signals 248.

The RF PA 216 amplifies the multiplexed signal 250 and the resulting amplified signal 252 is transmitted via the antenna 218 as an uplink signal 254, for reception by the satellite 102. The satellite 102 recovers the combined beam element signals 240, i.e., as affected by the transmission and reception operations, and applies them through respective transmit signal paths for transmission from their corresponding antenna elements in the phased array antenna, for formation of the N beams.

FIG. 7 illustrates a variation on the arrangement of FIG. 6, where the uplink transmission is optical rather than RF. Instead of depicting the entire arrangement again, FIG. 7 depicts the signal path differences associated with optical signal transmission. Rather than the analog signals 248 feeding into the RF multiplexer 212, the first terrestrial terminal 100 includes an optical multiplexer 260 that forms a multiplexed signal 262 in the optical domain. Each one among a plurality of optical carriers 264 is modulated according to a respective one of the analog signals 248, to yield a corresponding optical channel signal. The optical multiplexer 260 uses wavelength division multiplexing (WDM) to multiplex the optical channel signals, to form the multiplexed signal 262. Again, the analog signals 248 or, more fundamentally, the combined beam element signals 240 that they represent, may be considered as being “stacked” in frequency.

An optical PA 266 amplifies the multiplexed signal 262 and the resulting amplified signal 268 is output from an optical telescope 270 as an uplink signal 272. In comparison with FIG. 6, the uplink signal 272 is a composite or multiplexed signal in the optical domain having a plurality of optical channel signals at respective optical wavelengths. Each optical channel signal conveys a respective one of the combined beam element signals 240. In the context of FIG. 6, a similar arrangement pertains but the uplink signal 254 is a composite or multiplexed signal in the RF domain having a plurality of RF channel signals at respective carrier frequencies, with each RF channel signal conveying a respective one of the combined beam element signals 240.

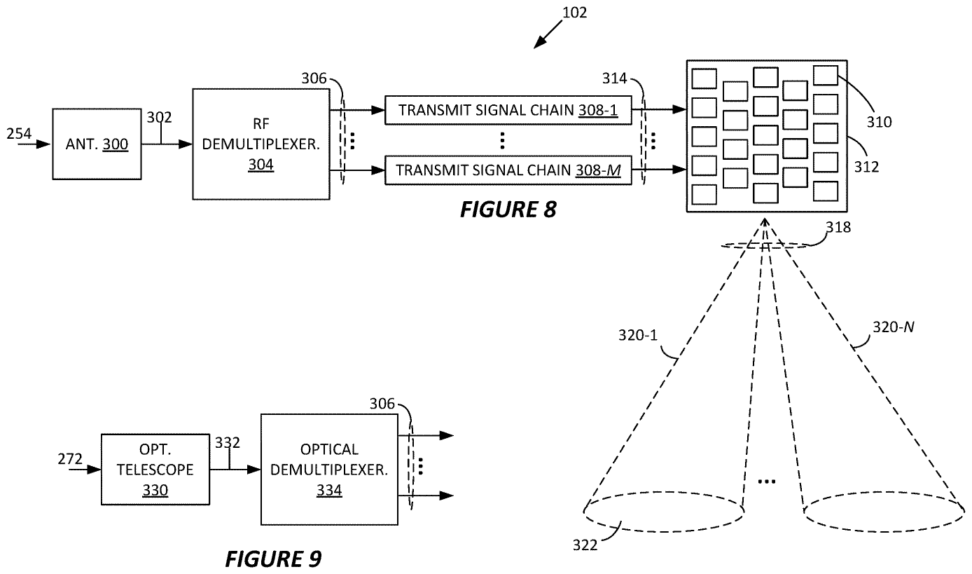

FIG. 8 illustrates example details at the satellite 102 for reception of the uplink signal 254, where the satellite 102 includes an antenna 300 configured for receiving the uplink signal 254. The received signal 302 output from the antenna 300 feeds into a RF demultiplexer 304, and there may be an intervening low-noise amplification stage between the antenna and demultiplexer that is not shown.

The RF demultiplexer 304 outputs a plurality of demultiplexed signals 306, which can be understood as recovered versions of the analog signals 248 shown in FIG. 6. Each demultiplexed signal 306 thus corresponds directly to one among the plurality of combined beam element signals 240, and each demultiplexed signal 306 feeds into the input side of a transmit signal chain 308. There is a respective transmit signal chain 308 for each of the M antenna elements 310 in a phased array antenna 312 of the satellite 102. Each transmit signal chain 308-1 through 308-M includes, for example, a frequency converter and one or more amplification stages, e.g., a PA, and each transmit signal chain 308-1 imparts a respective, characterizable non-linearity to the demultiplexed signal 306 that is input to it.

With their per-element associations, the signals output from the respective transmit signal chains 308 are referred to as antenna element signals 314, with each such antenna element signal 314 applied to the antenna feed of the corresponding antenna element 310. Thus, the downlink signals 318 emitted from the phased array antenna 312 are transmitted versions of the antennal element signals 314. As a consequence of the beam weightings and combining performed in the first terrestrial terminal 100 to produce the combined beam element signals 240, the downlink signals 318 superpose in the far field, to form N beams 320. Each one of the N beams 320 corresponds to a respective one among the plurality of sets of beam weights 236 shown in FIG. 6, and each beam 320 has a corresponding beam coverage area 322.

In an example where the first terrestrial terminal 100 is a GT 22, the N beams 320 are forward user beams and the beam coverage areas 322 are forward user beam coverage areas. In an overall population of UTs 24 distributed over a satellite service area associated with the satellite 102, different subsets of UTs 24 are served by different ones of the forward user beams, in dependence on UT locations.

FIG. 9 illustrates differences in the satellite 102 for an optical uplink implementation. In this embodiment, the satellite 102 includes an optical telescope 330 for receiving the uplink signal 272 shown in FIG. 7. The received optical signal 332 output from the optical telescope 330 feeds into an optical demultiplexer 334, which demultiplexes the received optical signal 332 to recover the individual optical channel signals. Although not shown, each recovered optical channel signal drives a photodetector or other opto-electrical sensor that outputs an electrical domain signal 306, as shown in FIG. 8. Hence, the contents of the combined beam element signals 240 may be impressed onto respective RF carriers or respective optical carriers, with the resulting plurality of RF or optical channel signals multiplexed in a stacked spectrum arrangement for uplink transmission to the satellite 102.

A complication in the GBBF scenario is that each one of the combined beam element signals 240 is associated with a different combination of transmit signal chains and, more particularly, with a different combination of amplifiers used in transmission and retransmission. Although the multiplexed signal 250 shown in FIG. 6 is amplified by a single RF PA 216, the satellite 102 demultiplexes the corresponding received signal and each demultiplexed signal 306 is amplified by a different one among the plurality of transmit signal chains 308 onboard the satellite 102, with each such chain having its own amplification stage(s). The same thing holds for the optical uplink example of FIGS. 7 and 9.

Thus, characterizing the combined nonlinearity associated with terrestrial transmission and satellite retransmission must be done on a per element basis, i.e., with respect to the individual transmit signal chains 308 onboard the satellite 102. That is, it is necessary to characterize the nonlinearity of the first transmit signal chain in the terrestrial terminal 100 that is used for uplink transmission to the satellite 102, whether that transmit signal chain includes the RF PA 216 shown in FIG. 6 or the optical PA 266 shown in FIG. 7, in combination with each transmit signal chain 308 onboard the satellite 102. The resulting “per element” characterizations of combined nonlinearity are represented in FIG. 6 as the per-element predistortion values 244. Thus, each combined beam element signal 240 is pre-distorted using a set of values or a mathematical function that is particularized for the satellite transmit signal chain 308 to be used in its transmission from the phased array antenna 312 onboard the satellite.

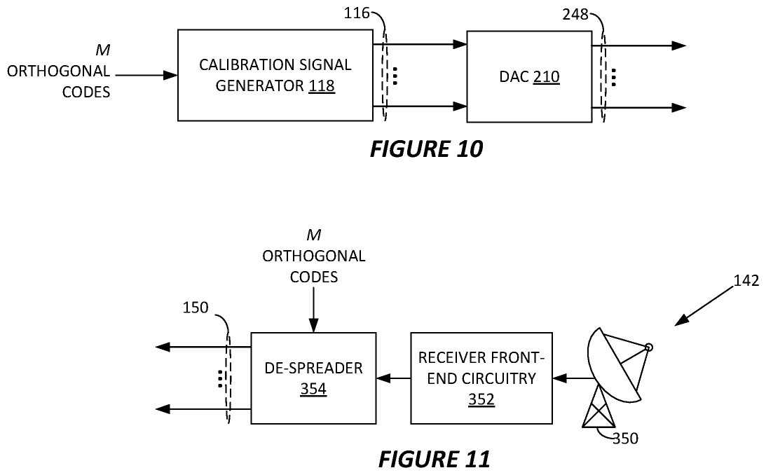

FIG. 10 illustrates an embodiment of the calibration signal generator 118 that was first shown in FIG. 4. Here, the calibration signal generator 118 generates a respective calibration signal 116 for each of the M transmit signal chains 308 onboard the satellite 102, with each calibration signal 116 being orthogonal with respect to the others. For example, the calibration signal generator 118 uses M orthogonal codes to generate the plurality of calibration signals 116. In at least one embodiment, the calibration signal generator uses M orthogonal spreading codes, to generate the plurality of calibration signals 116 as code division multiple access (CDMA) signals.

With reference to FIG. 6, during performance of the calibration procedure, the plurality of CDMA signals are input directly into the DAC 210, meaning that they are multiplexed and amplified for uplink transmission to the satellite 102, as would be normal communications signals. In this sense, the first or ground-based transmit signal chain of the first terrestrial terminal 100 includes the RF PA 216, which is common to all M calibration signals 116.

The CDMA-based calibration signals 116 are looped back by the satellite 102 transparently—i.e., no de-spreading—and the downlink signal returned by the satellite 102 during calibration in this scenario contains a plurality of return signals, each one corresponding to a different one among the M antenna elements 310 of the phased array antenna 312 onboard the satellite 102, and each one exhibiting nonlinearities specific to the corresponding transmit signal chain 308 used for transmitting from that particular antenna element 310. FIG. 11 illustrates a ground receiving arrangement, which may be included in the first terrestrial terminal 100 or in a second terrestrial terminal 170 that is directly or indirectly in communication with the first terrestrial terminal 100.

The downlink signal 142 in this embodiment contains looped back versions of the plurality of orthogonal calibration signals 116 transmitted from the first ground station 100 to the satellite 102, with the downlink signal 146 being received by an antenna 350. In this example embodiment, the per element calibration signals 116 are not weighted, meaning that there is no beamforming from the phased array antenna 312. As such, unlike beamformed transmission of communications signals, there is no beamforming gain associated with reception of the downlink signal 146. Thus, the antenna 350 must have sufficient gain to provide a threshold received signal strength. The first ground station 100 may be supplemented with the antenna 350 for calibration use, or it may inherently include a suitable antenna.

The antenna 350 feeds into receiver front-end circuitry 352, such as filters, LNAs, downconverters, etc., and the output from the receiver front-end circuitry 352 feeds into a de-spreader 354. The de-spreader 354 uses the same set of M orthogonal codes used by the calibration signal generator to orthogonalize the calibration signals 116 to de-spread individual return signals 150. Each return signal 150 reflects the combined nonlinearities associated the transmit signal chain of the first terrestrial terminal 100 and a specific one of the M transmit signal chains 308 that are used onboard the satellite 102 for beamforming communications signals.

In one or more GBBF embodiments, the calibration procedure, with its use of the plurality of calibration signals 116, characterizes the phase and amplitude nonlinearity of the ground-based transmit signal chain, with its included PA, in combination with each space-based, per-element transmit signal chain 308. The calibration signals 116 are swept in amplitude and phase at each of one or more frequencies. Characterization of nonlinearity is based on evaluating each resulting return signal 150 in terms of amplitude and phase, for deviations from the expected linear response. DPD derives from these characterizations. In at least one embodiment, this process is performed at different frequencies across the band of interest because both the phase and amplitude nonlinear characteristics may change as a function of frequency. And, again, for the phased array context, the characterization is per element, to account for the fact that the different transmit signal chains 308 onboard the satellite may have unique amplitude and phase transfer functions vs amplitude of the input signal.

Broadly, the first terrestrial terminal 100 and the satellite 102 in one or more embodiments are configured to perform GBBF, where the first terrestrial terminal 100 multiplexes and transmits via a first transmit signal chain a composite uplink communications signal. The satellite 102 includes a plurality of second transmit signal chains, each feeding a respective antenna element of a phased array antenna onboard the satellite that is used in GBBF. The calibration procedure thus includes generating a plurality of orthogonal calibration signals, each orthogonal calibration signal mapped for retransmission via a corresponding one among the plurality of per-element transmit signal chains.

In this context, transmitting the uplink signal from the first terrestrial terminal 100 comprises stacking the plurality of orthogonal calibration signals in the frequency domain, for transmission to the satellite 102 as a composite uplink calibration signal output by the first transmit signal chain of the terrestrial terminal 100. Further, receiving the downlink signal comprises receiving a composite downlink signal comprising a plurality of return signals stacked in the frequency domain, each return signal being a retransmission of a respective one among the plurality of orthogonal calibration signals as received at the satellite 102 and retransmitted from the corresponding one among the plurality of per-element transmit signal chains.

Characterizing the combined nonlinearity in this context thus comprises characterizing a combined nonlinearity of the first transmit signal chain with respect to each one among the plurality of per-element transmit signal chains. Correspondingly, with respect to pre-distorting communications signals, the communications signals comprise a plurality of combined beam element signals, each one to be transmitted from a particular one among the antenna elements of the phased array antenna onboard the satellite 102. Thus, each combined beam element signal is pre-distorted as a function of the characterized combined nonlinearity determined for the first transmit signal chain in the first terrestrial terminal 100 and the second transmit signal chain onboard the satellite 102 that corresponds with the particular antenna element.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-14. (canceled)

15. A method of operation in a satellite communications system (SCS), the method comprising:
generating a calibration signal at a gateway terminal of the SCS, the calibration signal being swept in amplitude for each frequency among a plurality of frequencies in a defined frequency range;
transmitting an uplink signal from the gateway terminal for reception by the bent-pipe satellite, based on inputting the calibration signal into a first transmit signal chain of the gateway terminal;
receiving a downlink signal from the bent-pipe satellite, the downlink signal received at the gateway terminal, and recovering a return signal from the downlink signal, the return signal being retransmission of the calibration signal as received at the bent-pipe satellite, the retransmission performed via a second transmit signal chain onboard the bent-pipe satellite;
characterizing a nonlinear gain and phase response exhibited by the return signal versus signal amplitude, by comparing corresponding signal values of the calibration signal and the return signal; and
with respect to a communications signal to be transmitted from the gateway terminal via the first transmit signal chain for retransmission by the bent-pipe satellite via the second transmit signal chain, pre-distorting the communications signal in the digital domain using pre-distortion values corresponding with an amplitude of the communications signal, to at least partly compensate for the characterized nonlinear gain and phase response.

16. The method according to claim 15, wherein the first transmit signal chain includes an amplification stage operated at different operating points when used for transmitting communications signals, and wherein the pre-distortion values are operating point dependent.

17. The method according to claim 15, wherein the uplink signal is an optical uplink signal.

18. The method according to claim 15, wherein the uplink signal is a radiofrequency (RF) uplink signal.

19. The method according to claim 15, wherein generating the calibration signal comprises sweeping a continuous wave (CW) signal over a defined amplitude sweep range, for each of the plurality of frequencies in the defined frequency range.

20. The method according to claim 15, wherein the gateway terminal and the bent-pipe satellite are configured for ground based beamforming (GBBF), with the communications signal being one among a plurality of beam element signals that are multiplexed and transmitted via the first transmit signal chain as a composite uplink communications signal, and with the second transmit signal chain being a respective one among a plurality of per-element transmit signal chains feeding a respective antenna element of a phased array antenna onboard the bent-pipe satellite used in the GBBF.

21. The method according to claim 20,
wherein generating the calibration signal comprises generating a plurality of orthogonal calibration signals, each orthogonal calibration signal mapped for retransmission via a corresponding one among the plurality of per-element transmit signal chains, the orthogonal calibration signals being swept in amplitude for each of the plurality of frequencies in the defined frequency range,
wherein transmitting the uplink signal comprises stacking the plurality of orthogonal calibration signals in the frequency domain, for transmission to the bent-pipe satellite as a composite uplink calibration signal output by the first transmit signal chain,
wherein receiving the downlink signal comprises receiving a composite downlink return signal comprising a plurality of return signals stacked in the frequency domain, each return signal being a retransmission of a respective one among the plurality of orthogonal calibration signals as received at the bent-pipe satellite and retransmitted from the corresponding one among the plurality of per-element transmit signal chains, and
wherein characterizing the nonlinear gain and phase response comprises determining a characterized nonlinear gain and phase response exhibited by each return signal, based on comparing corresponding signal samples of each return signal and the corresponding one among the plurality of orthogonal calibration signals.

22. The method according to claim 21, wherein each beam element signal is mapped for retransmission from a corresponding one of the per-element transmit signal chains, and wherein the method includes pre-distorting each beam element signal according to the characterized nonlinear gain and phase response corresponding to the per-element transmit signal chain to which the beam element signal is mapped.

23. The method according to claim 21, wherein generating the plurality of orthogonal calibration signals comprises applying orthogonal coding to a same amplitude-swept continuous wave (CW) signal, to form the plurality of orthogonal calibration signals.

24. The method according to claim 23, wherein applying the orthogonal coding comprises spreading the amplitude-swept CW signal separately, with each one among a plurality of Code Division Multiple Access (CDMA) codes.

25. A gateway terminal configured for operation in a satellite communications system (SCS), wherein the gateway terminal comprises:
processing circuitry configured to generate a calibration signal, the calibration signal being swept in amplitude for a plurality of frequencies, over a defined frequency range;
a transmit signal chain configured to form an uplink signal from the calibration signal, for transmission to the bent-pipe satellite; and
a receiving antenna and associated receiver circuitry configured to receive a downlink signal from the bent-pipe satellite and recover a return signal from the downlink signal, the return signal being a retransmission of the calibration signal as received at the bent-pipe satellite, where the retransmission is performed via a second transmit signal chain onboard the bent-pipe satellite; and
wherein the processing circuitry is further configured to:
characterize a nonlinear gain and phase response exhibited by the return signal versus signal amplitude, by comparing corresponding signal values of the calibration signal and the return signal; and
with respect to a communications signal to be transmitted from the gateway terminal via the first transmit signal chain for retransmission by the bent-pipe satellite via the second transmit signal chain, pre-distort the communications signal in the digital domain using pre-distortion values corresponding with an amplitude of the communications signal, to at least partly compensate the communications signal according to the characterized nonlinear gain and phase response.

26. The gateway terminal according to claim 25, wherein the transmit signal chain includes an amplification stage operated at different operating points when used for transmitting communications signals, and wherein the pre-distortion values are operating point dependent.

27. The gateway terminal according to claim 25, wherein the uplink signal is an optical uplink signal.

28. The gateway terminal according to claim 25, wherein the uplink signal is a radiofrequency (RF) uplink signal.

29. The gateway terminal according to claim 25, wherein, to generate the calibration signal the processing circuitry is configured to sweep a continuous wave (CW) signal over a defined amplitude sweep range, for each of the plurality of frequencies in the defined frequency range.

30. The gateway terminal according to claim 25, wherein the gateway terminal and the bent-pipe satellite are configured for ground based beamforming (GBBF), with the communications signal being one among a plurality of beam element signals that are multiplexed and transmitted via the first transmit signal chain as a composite uplink communications signal, and with the second transmit signal chain being a respective one among a plurality of per-element transmit signal chains feeding a respective antenna element of a phased array antenna onboard the bent-pipe satellite used in the GBBF.

31. The gateway terminal according to claim 30,
wherein the processing circuitry is configured to generate the calibration signal as a plurality of orthogonal calibration signals, each orthogonal calibration signal mapped for retransmission via a corresponding one among the plurality of per-element transmit signal chains, the orthogonal calibration signals being swept in amplitude for each of the plurality of frequencies in the defined frequency range,
wherein the gateway terminal is configured to transmit the uplink signal by stacking the plurality of orthogonal calibration signals in the frequency domain, for transmission to the bent-pipe satellite as a composite uplink calibration signal output by the first transmit signal chain,
wherein the downlink signal is a composite downlink return signal comprising a plurality of return signals stacked in the frequency domain, each return signal being a retransmission of a respective one among the plurality of orthogonal calibration signals as received at the bent-pipe satellite and retransmitted from the corresponding one among the plurality of per-element transmit signal chains, and
wherein the processing circuitry is configured to characterize the nonlinear gain and phase response by determining a characterized nonlinear gain and phase response exhibited by each return signal, based on comparing corresponding signal samples of each return signal and the corresponding one among the plurality of orthogonal calibration signals.

32. The gateway terminal according to claim 31, wherein each beam element signal is mapped for retransmission from a corresponding one of the per-element transmit signal chains, and wherein the processing circuitry is configured to pre-distort each beam element signal according to the characterized nonlinear gain and phase response corresponding to the per-element transmit signal chain to which the beam element signal is mapped.

33. The gateway terminal according to claim 31, wherein the processing circuitry is configured to generate the plurality of orthogonal calibration signals by applying orthogonal coding to a same amplitude-swept continuous wave (CW) signal, to form the plurality of orthogonal calibration signals.

34. The gateway terminal according to claim 33, wherein, to apply the orthogonal coding, the processing circuitry is configured to spread the amplitude-swept CW signal separately, with each one among a plurality of Code Division Multiple Access (CDMA) codes.
